(19) United States
(12) Patent Application Publication
(10) Pub. No.: US 2006/0254316 A1
(43) Pub. Date: Nov. 16, 2006

(54) Method for manufacturing gradient refractive index lens

(75) Inventor: Charles Leu, Fremont, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/389,398

(22) Filed: Mar. 24, 2006

(30) Foreign Application Priority Data
May 13, 2005 (CN) 200510034655.1

(51) Int. Cl. C03B 32/00

(52) U.S. Cl. 65/30.13; 65/111

(57) ABSTRACT

A method for manufacturing a gradient refractive index lens includes the steps of: putting a lens body having a desired shape into an ion implanter; vacuumizing the ion implanter; and implanting ions of a dopant material into the lens body such that the ions have a predetermined concentration gradient therein.

### TECHNICAL FIELD

The present invention relates to a method for manufacturing lenses, and more particularly to a method for manufacturing a gradient refractive index lens.

### BACKGROUND

Nowadays, the most common gradient refractive index (GRIN) optical components include axial and radial GRIN lenses and GRIN optical fibers. Axial GRIN lenses are usually used to adjust spherical aberration and simplify optical systems. Radial GRIN lenses have more advantages than axial GRIN lenses. For example, many radial GRIN lenses are self-focused. Therefore such lenses are widely used in optical communications components such as circulators, couplers, switches, dense wavelength-division multiplexers (DWDMs) and light emitting diodes (LEDs). GRIN optical fibers are now widely used in long and short distance information transmission.

Gradient refractive index optical components such as GRIN lenses and optical fibers are presently manufactured by any of a variety of methods including ion exchange, Sol-Gel, bulk diffusion, and chemical vapor deposition (CVD).

A typical ion exchange method for producing gradient refractive index lenses is as follows. The method includes a first step in which a glass body is immersed into a molten salt. The molten salt contains ions, which have a refractive index higher than that of ions constituting the glass body. This results in ion diffusion into the glass body. In a second step, the glass body is then immersed into another molten salt. This other molten salt contains ions which have a refractive index lower than that of the ions of the molten salt used in the first step. Thus a predetermined refractive index distribution in the glass body is obtained.

The ion exchange method is a comparatively simple and established technique for producing GRIN lenses. However, it is generally almost impossible to make large components, or components with a high refractive index gradient. In addition, products made by this method frequently do not have uniform quality. The yield of satisfactory quality products may be relatively low, which results in high production costs.

A typical Sol-Gel method for making glass gradient refractive index components is initiated by forming a mixture of silicon alkoxide and an alcohol in a solution sufficiently acidic to partially hydrolyze the silicon alkoxide. An index modifying metal alkoxide, such as titanium alkoxide and zirconium alkoxide, is then added to the mixture. Water is then added to convert the metal alkoxide to a network of corresponding metal oxides suitable for gelation. The mixture containing the network of metal oxides is then maintained for a sufficient time to form a gel. The gel is acid leached until some of the index modifying metal oxides are removed. The gel is then stabilized, to prevent further removal of index modifying metal oxides from the gel. The stable gel is then rinsed with a solvent to remove precipitates from the gel, dried, and finally sintered into a transparent gradient refractive index glass body such as a rod. In another version of this method, the stabilizing agent is acetone or a mixture of water and acetone.

Generally the Sol-Gel method employs a gel, which allows the metal salts used to modify the refractive index to travel easily. The gel is finally sintered to become a transparent glass rod. Thus the difficulties of ion dispersion of the ion exchange method are circumvented. However, the sintered glass rod is often more brittle and less transparent than one produced by the ion exchange method. In addition, the processing cycle may take a long time, such as 7 to 10 days.

Certain bulk diffusion methods have been developed. Typically, layers of glass plates having different refractive indices and compositions are stacked. Thus an initial discontinuous gradient refractive index distribution is attained. A highly controlled thermal treatment is used to blur the interfaces in the stack, and smooth the initially sharp gradient curve. Large-dimension components with selectable refractive index gradients can be attained using the bulk diffusion method, and the initial refractive index distribution is easily controlled. Various kinds of optical glass and even optical polymer material can be used to produce GRIN lenses. However, the method can only be used to manufacture axial GRIN lenses. The method cannot be used to manufacture the more popular radial GRIN lenses.

In general, the CVD method includes the following main steps. Accompanying chemical reactions, chemical vapor with continuously changing composition is deposited on tube-shaped or plate-shaped substrates layer by layer. The substrates are then sintered to form a transparent glass rod that has a predetermined refractive index distribution. This technique can be precisely controlled. However, the technique is not easy to perform, and requires a long production cycle.

Therefore, a simple method for manufacturing a gradient refractive index lens with high precision is desired.

### SUMMARY

A method for manufacturing a gradient refractive index lens includes the steps of: putting a lens body having a desired shape into an ion implanter; vacuumizing the ion implanter; and implanting ions of a dopant material into the lens body such that the ions have a predetermined concentration gradient therein.

Other advantages and novel features will become more apparent from the following detailed description when taken in conjunction with the accompanying drawings, in which:

### BRIEF DESCRIPTION OF THE DRAWINGS

Many aspects of the present method for manufacturing a gradient refractive index lens can be better understood with reference to the following drawings. The components in the drawings are not necessarily to scale, the emphasis instead being placed upon clearly illustrating the principles of the present method for manufacturing a gradient refractive index lens. Moreover, in the drawings, like reference numerals designate corresponding parts throughout the several views.

FIG. 1 is a schematic view of an ion implanter for implanting a dopant material into a lens body in accordance with an embodiment of the present invention.

FIG. 2 is a schematic view of a gradient refractive index lens formed in accordance with an embodiment of the present invention.

### DETALILED DESCRIPTION OF THE EMBODIMENTS

The present invention is further described below with reference to the figures.

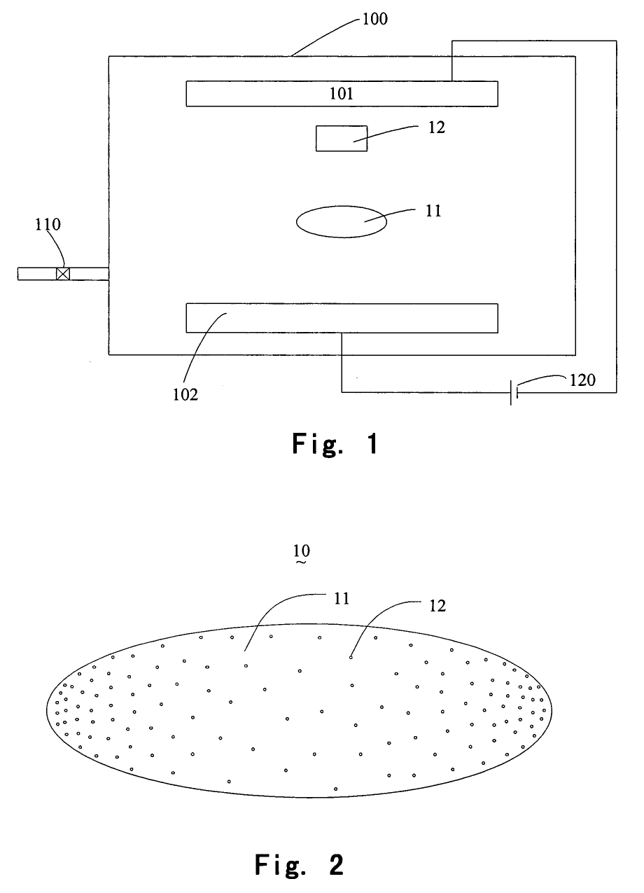

Referring to FIG. 1 and FIG. 2, a method for manufacturing a gradient refractive index lens 10 is provided. The method comprises the steps of:
putting a lens body 11 having a desired shape into an ion implanter 100;
vacuumizing the ion implanter 100; and
implanting ions of a dopant material 12 into the lens body 11 such that the ions have a predetermined concentration gradient therein.

The method for manufacturing the gradient refractive index lens 10 is described in more detail below and by reference to embodiments.

Firstly, the lens body 11 having a desired shape is put into the ion implanter 100. In particular, the lens body 11 having a desired shape is provided. The lens body 11 can be formed by different methods according to different materials used, such methods including for example press molding, injection molding, etc. The lens body 11 can for example be made from glass or polymer. The glass may be quartz glass or silicate glass. The polymer may be polycarbonate (PC) or polymethyl methacrylate (PMMA). The lens body 11 can be in the form of a spherical lens or an aspheric lens. In the preferred embodiment, the lens body 11 is formed as an aspheric lens by injection molding PMMA. For better surface precision of the lens body 11, rapid heat cycle molding is employed as the injection molding method.

Secondly, the ion implanter 100 is vacuumized. In the preferred embodiment, the ion implanter 100 is sealed, and then the ion implanter 100 is vacuumized with a vacuum pump 110.

Finally, ions of a dopant material 12 are implanted into the lens body 11 such that the ions have a predetermined concentration gradient therein. The dopant material 12 may be selected from the group comprising of germanium, titanium, silver, and cesium. The predetermined concentration gradient can be a radial concentration gradient or an axial concentration gradient. In the preferred embodiment, silver is employed as the dopant material 12. The implanting process comprises the following steps: forming silver ions (not shown) by ionizing the silver under vacuum in the ion implanter 100; forming ion beams by accelerating the silver ions with an electric field formed between two electrode plates 101, 102 connected by a power supply 120; and implanting the accelerated silver ions into the lens body 11 such that the ions have a radial concentration gradient therein. The concentration of silver ions increases from the center to the edge of the lens body 11, which is attained by adjusting the numbers of silver ions in the ion beams and the number of times that the lens body 11 is passed through a path or paths of the ion beams. The implanting depth of the silver ions is controlled by adjusting the energy levels of the ion beams, which in turn is attained by adjusting the electric field intensity between the electrode plates 101, 102.

FIG. 2 shows the gradient refractive index lens 10 formed by the method according to the preferred embodiment. The gradient refractive index lens 10 comprises the lens body 11 having a desired shape, and silver ions of the dopant material 12 dispersed in the lens body 11, with the silver ions having a radial concentration gradient. The concentration distribution of the silver ions increases from the center to the edge of the lens body 11. Therefore, the refractive index of the gradient refractive index lens 10 increases from the center to the edge thereof. It is to be noted that gradient refractive index lenses with other predetermined concentration gradients, for example an axial concentration gradient, can also be formed by the method according to the preferred embodiment.

In summary, the method for manufacturing the gradient refractive index lens can employ conventional methods for making the lens body thereof, and the overall process is simple and relatively inexpensive. Further, distributing the dopant material into the lens body by ion implanting controls the dispersion of the dopant with high precision. Accordingly, the precision of the gradient refractive index of the gradient refractive index lens is high. In addition, ion implanting does not require heating of the lens body. Therefore the shape and the size of the lens body is maintained respectively. Accordingly, the surface precision of the gradient refractive index lens is good.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A method for manufacturing a gradient refractive index lens, comprising the steps of:
putting a lens body having a desired shape into an ion implanter;
vacuumizing the ion implanter; and
implanting ions of a dopant material into the lens body such that the ions have a predetermined concentration gradient therein.

2. The method for manufacturing a gradient refractive index lens in accordance with claim 1, further comprising the step of forming the lens body by press molding or injection molding.

3. The method for manufacturing a gradient refractive index lens in accordance with claim 1, wherein the lens body is made from glass or polymer.

4. The method for manufacturing a gradient refractive index lens in accordance with claim 3, wherein the glass is quartz glass or silicate glass.

5. The method for manufacturing a gradient refractive index lens in accordance with claim 3, wherein the polymer is polycarbonate or polymethyl methacrylate.

6. The method for manufacturing a gradient refractive index lens in accordance with claim 1, wherein the lens body is spherical or aspheric.

7. The method for manufacturing a gradient refractive index lens in accordance with claim 1, wherein the dopant material is selected from the group consisting of germanium, titanium, silver, and cesium.

8. The method for manufacturing a gradient refractive index lens in accordance with claim 1, wherein the predetermined concentration gradient is a radial concentration gradient.

9. The method for manufacturing a gradient refractive index lens in accordance with claim 1, wherein the predetermined concentration gradient is an axial concentration gradient.

10. The method for manufacturing a gradient refractive index lens in accordance with claim 1, wherein the ions of the dopant material are implanted into the lens body by electric field acceleration.

11. A method for manufacturing a lens, comprising the steps of:
forming a lens body to be processed;
forming ions of a dopant material beside said lens body; and
forcing said ions to intrude into said lens body respectively without significantly deforming said lens body so as to form a lens having a gradient refractive index due to said intruding ions therein.

12. The method in accordance with claim 11, wherein each of said ions of said dopant material is electrically accelerated before intrusion thereof into said lens body.

13. A method for manufacturing a lens, comprising the steps of:
forming a lens body, having a designed final shape, to be processed;
preparing ions of a dopant material beside said lens body; and
forcibly introducing said ions into said lens body by maintaining said shape of said lens body so as to form a lens having said shape and a gradient refractive index due to said introduced ions therein.
